(19) United States
(12) Patent Application Publication
(10) Pub. No.: US 2014/0083825 A1
(43) Pub. Date: Mar. 27, 2014

(54) ELECTRIC CIRCUIT BREAKING DEVICE

(71) Applicant: Toyoda Gosei Co., Ltd., Kiyosu-shi (JP)

(72) Inventors: Takaki FUKUYAMA, Kiyosu-shi (JP); Yoshiki NAKAMURA, Kiyosu-shi (JP); Yoshiaki KAMEDA, Kiyosu-shi (JP)

(73) Assignee: Toyoda Gosei Co., Ltd., Kiyosu-shi (JP)

(21) Appl. No.: 13/967,282

(22) Filed: Aug. 14, 2013

(30) Foreign Application Priority Data
Sep. 26, 2012 (JP) 2012-212714

(51) Int. Cl. H01H 39/00

(52) U.S. Cl. CPC H01H 39/006
USPC 200/61.08

(57) ABSTRACT

An electric circuit breaking device includes a housing, which has an accommodating portion, and a bus bar, which extends through the accommodating portion. The housing has a receiving chamber, which has an opening that opens toward the bus bar. The housing also accommodates a cutting blade such that the cutting blade faces the receiving chamber with the bus bar in between. The cutting blade is moved toward the receiving chamber to apply a shearing force to the bus bar, thereby cutting the bus bar. A restraint position is defined in the vicinity of the cutting blade and in an area about the opening of the receiving chamber. The accommodating portion accommodates a block. At the restraint position, the block cooperates with the housing to hold the bus bar, thereby restraining movement of the bus bar.

### BACKGROUND OF THE INVENTION

The present invention relates to an electric circuit breaking device.

For example, automobiles having various electric circuits are equipped with a breaking device. Such a breaking device cuts a bus bar, which is part of an electric circuit, to stop supply of electricity to the electric circuit when there is an abnormality (refer to Japanese Patent Nos. 4228063 and 4344255). A bus bar extends through the housing of such a breaking device. The housing has a receiving chamber, which faces the bus bar. The housing also accommodates a cutting blade, which faces the receiving chamber with the bus bar in between. When the cutting blade is moved toward the receiving chamber, the cutting blade is pressed against the bus bar, so that a shearing force is applied to part of the bus bar that is located between the cutting edge and the opening of the receiving chamber. The shearing force cuts the bus bar.

### SUMMARY OF THE INVENTION

When a bus bar is cut by the cutting blade of a breaking device, the shearing force may displace or stretch the bus bar so that the bus bar is pulled into the receiving chamber. In such cases, it is difficult to cut the bus bar in a favorable manner by moving the cutting blade into the receiving chamber.

Accordingly, it is an objective of the present invention to provide an electric circuit breaking device that prevents a bus bar from being displaced or stretched into a receiving chamber when the bus bar is to be cut by a cutting blade.

To achieve the foregoing objective, and in accordance with one aspect of the present invention, an electric circuit breaking device is provided. The breaking device includes a housing, a bus bar, a receiving chamber, a cutting blade, and a block. The housing has an accommodating portion. The bus bar extends through the accommodating portion and forms part of an electric circuit. The receiving chamber is formed in the housing. The receiving chamber has an opening that opens toward the bus bar. The cutting blade is arranged in the housing and faces the receiving chamber with the bus bar in between. The cutting blade is moved toward the receiving chamber to apply a shearing force to the bus bar at a part between the cutting blade and the opening of the receiving chamber, thereby cutting the bus bar. The block is arranged in the accommodating portion. A restraint position is defined in the vicinity of the cutting blade and in an area about the opening of the receiving chamber. At the restraint position, the block cooperates with the housing to hold the bus bar, thereby restraining movement of the bus bar.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing the entirety of a breaking device according to one embodiment of the present invention;

FIG. 2 is a perspective view illustrating a structure for fixing the breaking device of FIG. 1 to a bus bar; and

FIG. 3 is a schematic diagram of the block and the bus bar, showing the cutting blade and its surroundings.

### DETAILED DESCRIPTION OF THE PREFERRED EMBODIMENTS

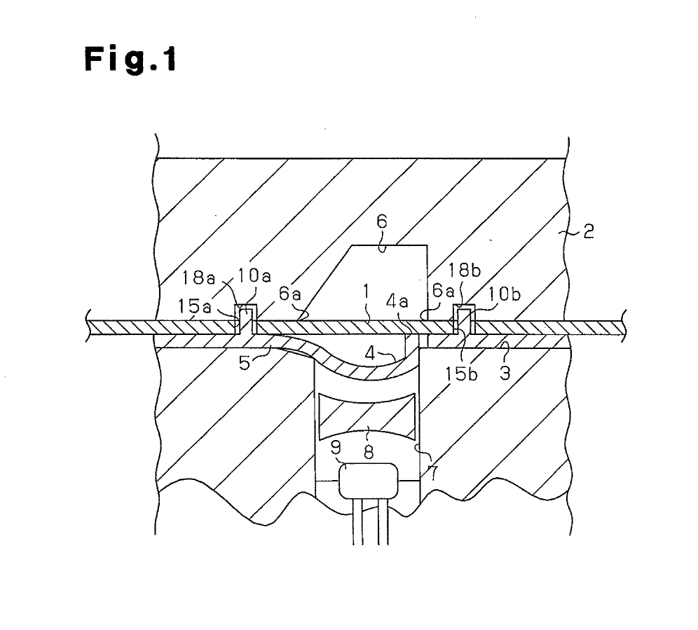

An electric circuit breaking device according to one embodiment of the present invention will now be described with reference to FIGS. 1 to 3.

The breaking device shown in FIG. 1 includes a housing 2 having an accommodating portion 3. A bus bar 1 extends through the accommodating portion 3 of the housing 2. The bus bar 1 is formed into a thin plate and is made of a material having a high electric conductivity, such as copper. The accommodating portion 3 extends in the same direction as the bus bar 1. The dimension of the accommodating portion 3 in the direction of the thickness of the bus bar 1 is constant. A plastic block 5 is attached to one side of the bus bar 1 in the thickness direction (the lower side as viewed in FIG. 1). With the block 5 attached to the bus bar 1, the bus bar 1 and the block 5 are fitted in the accommodating portion 3. Accordingly, the block 5 is elastically deformed to be compressed in the thickness direction of the bus bar 1. The elastic restoring force of the block 5 presses the bus bar 1 against the housing 2 in the thickness direction. In this manner, the block 5 and the housing 2 cooperate to restrict movement of the bus bar 1.

The housing 2 has a hole 7, which extends in the thickness direction of the bus bar 1 and communicates with a part of the accommodating portion 3. The housing 2 also has a receiving chamber 6, which includes an opening 6a located on a side of the accommodating portion 3 that corresponds to the bus bar 1. The hole 7 is located at a position corresponding to the receiving chamber 6. The block 5 has a cutting blade 4, which is located at a position corresponding to the hole 7. The cutting blade 4 is integrally formed with the block 5 and is movable in the thickness direction of the bus bar 1 through elastic deformation. In the housing 2, the receiving chamber 6 is arranged on one side of the bus bar 1 in the thickness direction (the upper side as viewed in FIG. 1). The cutting blade 4 is arranged on the other side of the bus bar 1 in the thickness direction (the lower side as viewed in FIG. 1) and faces the receiving chamber 6 with the bus bar 1 in between.

The hole 7 accommodates a hammer 8, which is movable in the thickness direction of the bus bar 1. The hammer 8 divides the interior of the hole 7 into two sections. Of the two sections, the section separated further away from the bus bar 1 accommodates a gas generator 9, which generates combustion gas by igniting and burning incorporated explosive. When the gas generator 9 generates combustion gas, the pressure in the hole 7 is raised. Accordingly, the hammer 8 is moved toward the bus bar 1, so that the cutting blade 4 is pressed against the bus bar 1. The cutting blade 4 has an edge portion 4a, which is pressed against the bus bar 1 to cut the bus bar 1.

As described above, the block 5 and the housing 2 cooperate to restrict movement of the bus bar 1. Therefore, at a first restraint position, which is defined in the vicinity of the cutting blade 4 and located in the area about the opening 6a of the receiving chamber 6, the block 5 cooperates with the housing 2 to restrict movement of the bus bar 1. A second restraint position is defined on the opposite side of the opening 6a of the receiving chamber 6 from the first restraint position at a position separated from the first restraint position in the direction in which the bus bar 1 extends. At the second restraint position also, the block 5 cooperates with the housing 2 to restrict movement of the bus bar 1. The position of the block 5 with respect to the bus bar 1 is determined at the first restraint position. The position of the block 5 with respect to the bus bar 1 is also determined at the second restraint position. The structure for determining the position of the block 5 with respect to the bus bar 1 will now be described.

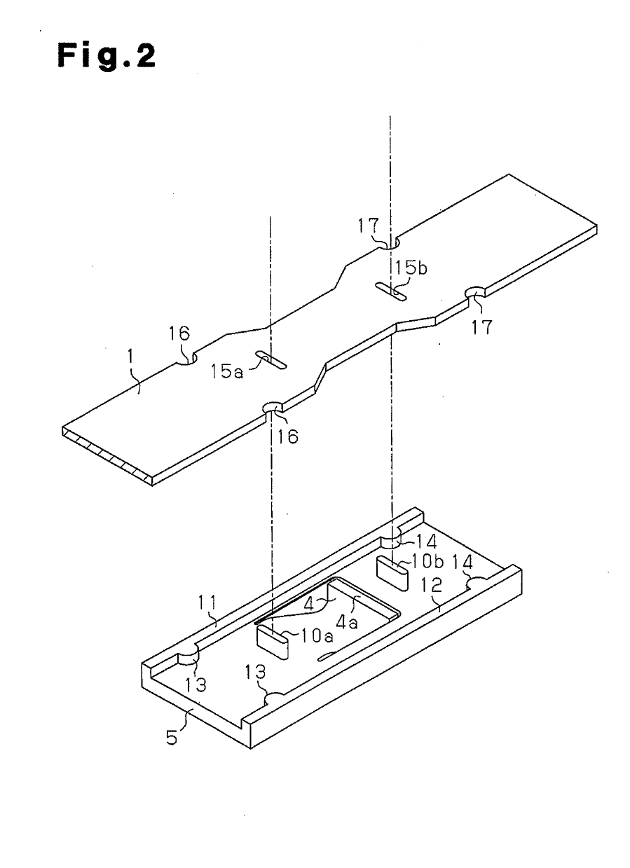

As shown in FIG. 2, the block 5 extends in the same direction as the bus bar 1. The block 5 has projections 10a, 10b at the first restraint position and the second restraint position, respectively. The projections 10a, 10b project toward the bus bar 1 and extend in the width direction of the bus bar 1. The block 5 has protrusions 11, 12 at edges in the width direction (corresponding to the width direction of the bus bar 1). The protrusions 11, 12 extend toward the bus bar 1 and extend in the same direction as the bus bar 1. Projections 13, which face each other, are formed on facing surfaces of the protrusions 11, 12. The projections 13 are located further away in the direction in which the bus bar 1 extends from the cutting blade 4 than the projection 10a. Projections 14, which face each other, are formed on the facing surfaces of the protrusions 11, 12. The projections 14 are located further away in the direction in which the bus bar 1 extends from the cutting blade 4 than the projection 10b.

The bus bar 1 has elongated holes 15a, 15b, which are spaced apart from each other by a predetermined distance in the direction in which the bus bar 1 extends. The elongated holes 15a, 15b extend through the bus bar 1 in the thickness direction. The elongated holes 15a, 15b function as fit-in portions, into which the projections 10a, 10b of the block 5 can be fitted. The elongated hole 15a is located at a position corresponding to the projection 10a, while the elongated hole 15b is located at a position corresponding to the projection 10b. The bus bar 1 has recesses 16, 17 on the sides in the width direction. The recesses 16, 17 function as fit-in portions into which the projections 13, 14 formed in the protrusions 11, 12 are fitted. The position of the block 5 is determined with respect to the bus bar 1 by fitting the projections 10a, 10b into the elongated holes 15a, 15b of the bus bar 1 and fitting the projections 13, 14 into the recesses 16, 17 of the bus bar 1.

The bus bar 1 has a narrow part between the elongated holes 15a, 15b, and the narrow part has a narrower width than the remaining part. The narrow part corresponds to the cutting blade 4 (the edge portion 4a) of the block 5, the position of which is determined with respect to the bus bar 1. The narrow part allows the bus bar 1 to be easily cut by the cutting blade 4.

The block 5, the position of which is determined with respect to the bus bar 1 as described above, is pushed into the accommodating portion 3 of the housing 2. At this time, the block 5 cooperates with the housing 2 to restrict movement of the bus bar 1 and determines the position of the bus bar 1 with respect to the housing 2 in the extending direction of the bus bar 1, as described below. The projecting amount of the projections 10a, 10b of the block 5 is set to be greater than the thickness of the bus bar 1. The housing 2 has recessed portions 18a, 18b at positions aligned with the projections 10a, 10b of the block 5. The recessed portions 18a, 18b open to the accommodating portion 3. The projections 10a, 10b, which are fitted in the elongated holes 15a, 15b of the bus bar 1, extend through the elongated holes 15a, 15b and are fitted into the recessed portions 18a, 18b of the housing 2. By fitting the projections 10a, 10b into the recessed portions 18a, 18b, the position of the block 5 is determined with respect to the housing 2 in the extending direction of the bus bar 1.

Operation of the breaking device as described above will now be described.

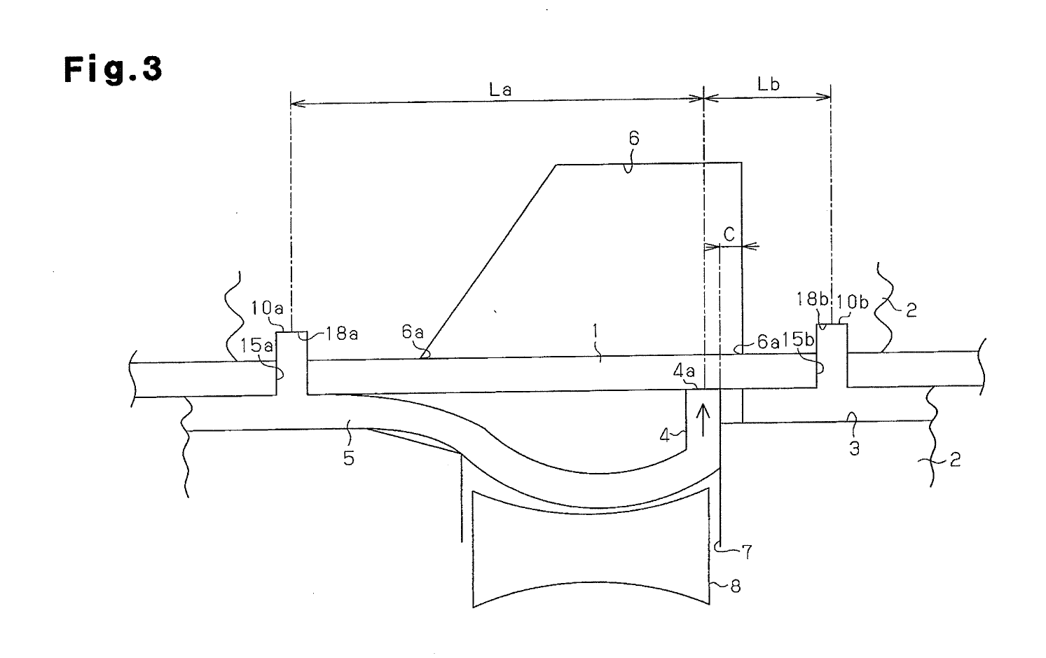

When an abnormality occurs, the breaking device cuts the bus bar 1, which is part of an electric circuit, to stop electricity supplied to the electric circuit. Specifically, the breaking device uses the gas generator 9 to generate combustion gas to increase the pressure in the hole 7, so that the hammer 8 is moved toward the bus bar 1. The moved hammer 8 pushes the cutting blade 4 toward the bus bar 1. As shown in FIG. 3, while contacting the bus bar 1, the edge portion 4a of the cutting blade 4 acts to pass the opening 6a of the receiving chamber 6 so that a shearing force is applied to part of the bus bar 1 that is located between the edge portion 4a and the opening 6a (a clearance C in FIG. 3). The shearing force cuts the bus bar 1.

When the shearing force acts on part of the bus bar 1 that is located between the edge portion 4a of the cutting blade 4 and the opening 6a of the receiving chamber 6 (the clearance C), the bus bar 1 is pulled toward the interior of the receiving chamber 6.

However, movement of the bus bar 1 is restricted by cooperation of the block 5 and the housing 2 at the first restraint position and the second restraint position. This prevents the restrained part of the bus bar 1 is prevented from being displaced into the receiving chamber 6. Since the restrained part of the bus bar 1 resists displacement toward the receiving chamber 6, the bus bar 1 is cut in a favorable manner as the cutting blade 4 is moved into the receiving chamber 6.

The restraint of the bus bar 1 by the block 5 reduces the distance between the restrained part of the bus bar 1 and the part of the bus bar 1 that contacts the edge portion 4a of the cutting blade 4. This reduces the length of part of the bus bar 1 that is stretched when the bus bar 1 is pulled toward the receiving chamber 6. In other words, between two restrained parts of the bus bar 1 (the parts corresponding to distances La, Lb in FIG. 3), the bus bar 1 is pulled and stretched toward the receiving chamber 6. The stretched part is shorter than when such restraint is not performed. Thus, the part of the bus bar 1 that corresponds to the distance La and the part that corresponds to the distance Lb are less likely to be stretched into the receiving chamber 6. Therefore, as the cutting blade 4 is moved into the receiving chamber 6, the bus bar 1 is cut in a favorable manner.

The above described embodiment has the following advantages.

(1) When the bus bar 1 is cut by the cutting blade 4, the edge portion 4a of the cutting blade 4 acts to pass the opening 6a of the receiving chamber 6 while contacting the bus bar 1. At this time, part of the bus bar 1 that extends between the edge portion 4a of the cutting blade 4 and the opening 6a of the receiving chamber 6 receives a shearing force. The shearing force pulls the bus bar 1 into the receiving chamber 6. However, movement of the bus bar 1 is restricted by the block 5 and the housing 2 at the first restrained position (the position of the projection 10b), which is in the vicinity of the edge portion 4a of the cutting blade 4, the restrained part of the bus bar 1 is prevented from being displaced into the receiving chamber 6. Therefore, as the cutting blade 4 is moved into the receiving chamber 6, the bus bar 1 is cut in a favorable manner. The distance Lb between the restrained part of the bus bar 1 and the part of the bus bar 1 contacting the edge portion 4a of the cutting blade 4 is short. That is, the distance of the part of the bus bar 1 that is stretched when the bus bar 1 is pulled toward the receiving chamber 6 is short. Thus, the bus bar 1 is less likely to be stretched into the receiving chamber 6, so that the bus bar 1 is cut in a favorable manner as the cutting blade 4 is moved into the receiving chamber 6.

(2) Movement of the bus bar 1 is restricted by cooperation of the block 5 and the housing 2 at the first restraint position and the second restraint position. Thus, in the area about the opening 6a of the receiving chamber 6, when the bus bar 1 is about to be cut and pulled toward the interior of the receiving chamber 6, the bus bar 1 is prevented from being displaced into the receiving chamber 6 not only at the first restraint position, which is in the vicinity of the edge portion 4a of the cutting blade 4, but also at the second restraint position, which is separated from the first restraint position and located on the opposite side of the opening 6a from the first restraint portion. Therefore, as the cutting blade 4 is moved into the receiving chamber 6, the bus bar 1 is more easily cut in a favorable manner. Also, when the bus bar 1 is pulled toward the receiving chamber 6 as described above, the part of the bus bar 1 between the first restraint position and the second restraint position of the restrained bus bar 1 (the portion corresponding to the distances La, Lb) is stretched. Since the stretched part is short, this part is even more unlikely to be stretched into the receiving chamber 6. Therefore, as the cutting blade 4 is moved into the receiving chamber 6, the bus bar 1 is cut in a favorable manner.

(3) The projections 10a, 10b formed on the block 5 are fitted into the elongated holes 15a, 15b formed in the bus bar 1 to determine the position of the block 5 with respect to the bus bar 1. The structure prevents the block 5 from being displaced in relation to the bus bar 1 so that the relative positions are maintained.

(4) The block 5 and the cutting blade 4 are formed integrally. The projections 10a, 10b formed on the block 5 are fitted into the recessed portions 18a, 18b formed in the housing 2 to determine the position of the block 5 with respect to the housing 2. The position of the block 5 with respect to the housing 2 has an influence on the clearance C between the edge portion 4a of the cutting blade 4 and the opening 6a of the receiving chamber 6 when the bus bar 1 is cut. Therefore, by determining the position of the block 5 with respect to the housing 2, the clearance C can be set to an optimal value, for example, for cutting the bus bar 1. That is, by determining the positions of the recessed portions 18a, 18b in the extending direction of the bus bar 1, the clearance C can be set to an optimal value.

(5) The projection 10a and the projections 13 of the block 5 are displaced from each other with respect to the extending direction of the bus bar 1. The positions of the elongated hole 15a and the recesses 16 in the bus bar 1 are displaced from each other in the extending direction of the bus bar 1 to be aligned with the projection 10a and the projections 13, respectively. If the elongated hole 15a and the recesses 16 are at the same position in the extending direction of the bus bar 1, the cross-sectional area of that section will be excessively small in the width direction of the bus bar 1. This may hinder the flow of electricity through the bus bar 1. However, since the elongated hole 15a and the recesses 16 are displaced from each other in the extending direction of the bus bar 1, the flow of electricity through the bus bar 1 is not hindered. Also, the projection 10b and the projections 14 of the block 5 are displaced from each other in the extending direction of the bus bar 1. Accordingly, the elongated hole 15b and the recesses 17 of the bus bar 1 are displaced from each other in the extending direction of the bus bar 1. The same advantage with regard to the flow of electricity as the above structure is achieved.

The above described embodiment may be modified as follows.

The cutting blade 4 and the block 5 do not necessarily need to be formed integrally, but may be formed separately.

The block 5 may be configured to cooperate with the housing 2 to restrict movement of the bus bar 1 only at the first restraint position.

The projections 10a, 10b of the block 5 are used not only for determining the position with respect to the bus bar 1, but also for determining the position with respect to the housing 2. Alternatively, the projections 10a, 10b of the block 5 do not necessarily need to be used for determining the position with respect to the housing 2, but may be used only for determining the position of the bus bar 1. For example, the block 5 may have an additional projection for determining the position with respect to the housing 2, and the position of the block 5 may be determined with respect to the housing 2 by fitting the additional projection into a recessed portion formed in the housing 2. In this case, the positional relationship between the projection and the recessed portion in the block 5 and the housing 2 may be reversed. Also, instead of providing a pair of one projection and one recessed portion, two or more pairs of projections and recessed portions may be provided.

The positional relationship between the projections 10a, 10b of the block 5 and the elongated holes 15a, 15b of the bus bar 1 may be reversed. That is, the bus bar 1 may have projections that correspond to the projections 10a, 10b, and the block 5 may have elongated holes that correspond to the elongated holes 15a, 15b.

In the above illustrated embodiment, the pair of the projection 10a and the elongated hole 15a and the pair of the projection 10b and the elongated hole 15b are provided. However, it is possible to provide only the pair of the projection 10b and the elongated hole 15b or only the pair of the projection 10b and the elongated hole 15b.

The sets of the projections 13 of the block 5 and the recesses 16 of the bus bar 1 may be omitted. Alternatively, the sets of the projections 14 of the block 5 and the recesses 17 of the bus bar 1 may be omitted.

The projection 10a and the elongated hole 15a may be omitted, and the position of the block 5 may be determined with respect to the bus bar 1 by using the projections 13 and the recesses 16. Alternatively, the projection 10b and the elongated hole 15b may be omitted, and the position of the block 5 may be determined with respect to the bus bar 1 by using the projections 14 and the recesses 17. In these cases, the projections 13 and the recesses 16 are preferably formed at positions corresponding to the projection 10a and the elongated hole 15a in FIG. 2. Also, the projections 14 and the recesses 17 are preferably formed at positions corresponding to the projection 10b and the elongated hole 15b in FIG. 2.

The block 5 may be formed by two separate bodies, which are coupled to each other with the bus bar 1 in between. In this case, it is preferable that the projections 10a, 10b of the block 5 be fitted into the elongated holes 15a, 15b of the bus bar 1 when the separate bodies are coupled to each other. This allows the position of the block 5 to be easily determined by the fitting. In this configuration, with the separate bodies coupled to each other, one of the projections 10a, 10b may extend through one of the separate bodies, and that part may be fitted in the recesses 18a, 18b of the housing 2.

The block 5 may be formed by the insert molding to be fixed to the bus bar 1 at the entire part contacting the bus bar 1. In this case, the block 5 and the housing 2 cooperate to more appropriately restrict movement of the bus bar 1. Therefore, even if the bus bar 1 is pulled toward the interior of the receiving chamber 6 when being cut, the bus bar 1 is prevented from being stretched or displaced. The bus bar 1 is therefore properly cut. In this case, the cutting blade 4 is preferably formed separately from the block 5 and attached to the block 5 after the insert molding.

Therefore, the present examples and embodiments are to be considered as illustrative and not restrictive and the invention is not to be limited to the details given herein, but may be modified within the scope and equivalence of the appended claims.

1. An electric circuit breaking device comprising:
a housing having an accommodating portion;
a bus bar, which extends through the accommodating portion and forms part of an electric circuit;
a receiving chamber formed in the housing, the receiving chamber having an opening that opens toward the bus bar;
a cutting blade, which is arranged in the housing and faces the receiving chamber with the bus bar in between, wherein the cutting blade is moved toward the receiving chamber to apply a shearing force to the bus bar at a part between the cutting blade and the opening of the receiving chamber, thereby cutting the bus bar; and
a block, which is arranged in the accommodating portion, wherein a restraint position is defined in the vicinity of the cutting blade and in an area about the opening of the receiving chamber, and, at the restraint position, the block cooperates with the housing to hold the bus bar, thereby restraining movement of the bus bar.

2. The electric circuit breaking device according to claim 1, wherein
the restraint position, which is located in the vicinity of the cutting blade, forms a first restraint position,
a second restraint position is defined, which is separated from the first restraint position in the extending direction of the bus bar and located on the opposite side of the opening of the receiving chamber from the first restraint portion,
at the first restraint position and the second restraint position, the block cooperates with the housing to hold the bus bar, thereby restraining movement of the bus bar.

3. The electric circuit breaking device according to claim 1, wherein
one of the block and the bus bar has a projection, and
the other one of the block and the bus bar has a fit-in portion, into which the projection can be fitted to determine the position of the block with respect to the bus bar.

4. The electric circuit breaking device according to claim 1, wherein the block is made of plastic and fixed to the bus bar at the entire part contacting the bus bar.

5. The electric circuit breaking device according to claim 1, wherein
the block is formed integrally with the cutting blade,
one of the block and the housing has a projection, and
the other one of the block and the housing has a recessed portion, into which the projection can be fitted to determine the position of the block with respect to the housing.
